(19) United States
(12) Patent Application Publication
(10) Pub. No.: US 2022/0329576 A1
(43) Pub. Date: Oct. 13, 2022

(54) SECURING COMMUNICATION BETWEEN A CLOUD PLATFORM AND AN APPLICATION HOSTED ON AN ON-PREMISE PRIVATE NETWORK

(71) Applicant: Hewlett Packard Enterprise Development LP, Houston, TX (US)

(72) Inventors: Sagar Ratnakara Nikam, Bangalore Karnataka (IN); John McVann, Corrandulla Galway (IE); Chiranjit Datta, Bangalore Karnataka (IN); Gandharva Shankara Murthy, Bangalore Karnataka (IN); Steven Roscio, Monument, CO (US)

(21) Appl. No.: 17/301,645

(22) Filed: Apr. 9, 2021

(51) Int. Cl. H04L 29/06; H04L 12/46

(52) U.S. Cl. CPC H04L 63/0435; H04L 63/102; H04L 63/0823; H04L 63/0236; H04L 63/0272; H04L 12/4633

(57) ABSTRACT

Examples described herein relate to securing communication between a cloud platform and applications running on an on-premise private network of a tenant. The cloud platform includes a communication delegate mapped to a tenant of the cloud platform. The communication delegate may receive data traffic associated with the tenant and directed to an application hosted on an on-premise private network. The communication delegate may encrypt the data traffic to generate an encrypted data traffic using a unique certificate associated with the communication delegate and communicate the encrypted data traffic to the application via a secure communication tunnel specific to the tenant between the communication delegate and the on-premise private network.

### BACKGROUND

Data and/or applications may be hosted on an on-premise private network or on a public cloud network, either having computing nodes, such as a server, a storage array, a cluster of servers, a computer appliance, a workstation, a storage system, a converged system, a hyperconverged system, or the like. In some examples, the data and/or applications hosted on the on-premise private network or on the public cloud network may be accessed via cloud based web-portals.

### BRIEF DESCRIPTION OF THE DRAWINGS

These and other features, aspects, and advantages of the present specification will become better understood when the following detailed description is read with reference to the accompanying drawings in which like characters represent like parts throughout the drawings, wherein:

FIG. 1 depicts a networked system including a cloud platform hosting a communication management system for enabling a secure communication with an application hosted on an on-premise private network, in accordance with an example;

FIG. 2 depicts a portion of a cloud network including network clusters hosting communication delegates, in accordance with an example;

FIG. 3 depicts a unique certificate associated with a communication delegate, in accordance with an example;

FIG. 4 depicts a block diagram of a communication controller hosted on a cloud platform, in accordance with an example;

FIG. 5 depicts a block diagram of a communication delegate hosted on a cloud platform, in accordance with an example;

FIG. 6 depicts a flow diagram of a method for providing secure communication between an application hosted on an on-premise private network and a cloud platform, in accordance with an example;

FIG. 7 depicts a flow diagram of a detailed method for providing secure communication between an application hosted on an on-premise private network and a cloud platform, in accordance with another example;

FIG. 8 depicts a flow diagram of a method for establishing a secure communication tunnel between a communication delegate hosted on a cloud platform and an on-premise private network, in accordance with an example;

FIG. 9 depicts a sequence diagram showing an example sequence of operations for setting-up a secure communication tunnel between a communication delegate and an on-premise private network, in accordance with an example;

FIG. 10 depicts a block diagram showing a processing resource and a machine-readable medium encoded with example instructions to direct data traffic to respective communication delegate of a plurality of communication delegates in a cloud platform, in accordance with an example; and

FIG. 11 depicts a block diagram showing a processing resource and a machine-readable medium encoded with example instructions to communicate data traffic from a cloud platform hosted on a cloud network to an application hosted on an on-premise private network, in accordance with an example.

It is emphasized that, in the drawings, various features are not drawn to scale. In fact, in the drawings, the dimensions of the various features have been arbitrarily increased or reduced for clarity of discussion.

### DETAILED DESCRIPTION

The following detailed description refers to the accompanying drawings. Wherever possible, same reference numbers are used in the drawings and the following description to refer to the same or similar parts. It is to be expressly understood that the drawings are for the purpose of illustration and description only. While several examples are described in this document, modifications, adaptations, and other implementations are possible. Accordingly, the following detailed description does not limit disclosed examples. Instead, the proper scope of the disclosed examples may be defined by the appended claims.

The terminology used herein is for the purpose of describing particular examples and is not intended to be limiting. As used herein, the singular forms “a,” “an,” and “the” are intended to include the plural forms as well, unless the context clearly indicates otherwise. The term “another,” as used herein, is defined as at least a second or more. The term “coupled,” as used herein, is defined as connected, whether directly without any intervening elements or indirectly with at least one intervening element, unless indicated otherwise. For example, two elements can be coupled mechanically, electrically, or communicatively linked through a communication channel, pathway, network, or system. Further, the term “and/or” as used herein refers to and encompasses any and all possible combinations of the associated listed items. It will also be understood that, although the terms first, second, third, etc. may be used herein to describe various elements, these elements should not be limited by these terms, as these terms are only used to distinguish one element from another unless stated otherwise or the context indicates otherwise. As used herein, the term “includes” means includes but not limited to, the term “including” means including but not limited to. The term “based on” means based at least in part on.

Data and/or applications may be stored on an on-premise private network or on public cloud network, either having computing nodes, such as a server, a storage array, a cluster of servers, a computer appliance, a workstation, a storage system, a converged system, a hyperconverged system, or the like. The term on-premise may be understood to mean, for example, on location at premises (e.g., real estate, such as a data center) owned (fully or partially), operated, or subscribed by an entity or at a colocation center rented to the entity. Accordingly, the on-premise private network is hereinafter referred to as on-premise private network of the entity. Further, the term ‘entity’ as used herein may refer to an individual or an organization having one or more users (e.g., owners, employees, contractors, or administrators). In the description hereinafter, the individual who is referred to as the entity or the users of the organization referred to as the entity are individually referred to as a user or collectively referred to as users associated with the entity. Also, the term “on-premise private network” is hereinafter interchangeably used as “on-premise network.”

In some examples, the data and/or applications hosted on the on-premise network or on the public cloud network may be accessible via cloud based portals, also referred to as cloud platforms. Certain cloud platforms may provide its tenants a cloud-like experience by allowing management and/or usage of capabilities such as, for example, IT infrastructure and/or services offered by the on-premise network, in a pay-per-use model. To avail such cloud-like experience facilitated by a cloud platform, the entity may be enrolled with the cloud platform as a tenant of the cloud platform. Once enrolled, users associated with the entity that is enrolled with the cloud platform as the tenant, are hereinafter referred to as tenant users. The tenant users can access, depending on respective access permissions, several applications including but not limited to virtual machines (VMs), containers, pods, machine-learning operations, data storage, compute, virtual networking, or the like, hosted on the on-premise network of the entity as services via the cloud platform in a pay-per-use model.

In order to reduce security threats to the applications associated with the entity, the applications are hosted behind a proxy and are safeguarded by firewalls at the on-premise network of the entity. On the other hand, the cloud platforms are generally designed to support a multitude of tenants. In certain cases, the cloud platform may manage IT infrastructure and/or services hosted at several on-premise networks each belonging to different tenants. To avail features offered by the cloud platform, the entities are to be enrolled with the cloud platform as tenants. For example, different entities may be registered/enrolled as different tenants of the cloud platform. Once enrolled, the users of the tenant (e.g., the enrolled entity) can access the applications hosted on respective on-premise networks via the cloud platform. Since, the cloud platform manages the on-premise networks associated with more than one tenant (e.g., enrolled entities) and the cloud platform itself may be hosted on a cloud network, it is useful that the cloud platform enable a secure communication between the cloud platform and the on-premise networks associated with the tenants. In other words, it is useful that the cloud platform does not allow access to the applications to unauthorized tenants.

Therefore, in accordance with the aspects of the present disclosure, a cloud platform is presented that enables secure communication with applications hosted on an on-premise network of a tenant of the cloud platform. The cloud platform may be hosted outside of the on-premise network of the tenant. In some examples, to enable such secure communication, the cloud platform may manage a plurality of communication delegates. In some examples, each of the plurality of communication delegates is mapped to a unique tenant of a plurality of tenants of the cloud platform. In other words, there may exist a separate unique communication delegate mapped to each tenant of the cloud platform. In some examples, the plurality of communication delegates are hosted as containerized applications on one or more clusters of computing nodes. During operation, a communication delegate mapped to the tenant may receive a data traffic associated with the tenant and directed to the application hosted on the on-premise network of the tenant. The communication delegate may encrypt the data traffic to generate an encrypted data traffic using a unique certificate associated with the communication delegate. In some examples, the unique certificate may include an identifier of the communication delegate and an Internet Protocol (IP) address associated with the communication delegate. Moreover, the communication delegate may communicate the encrypted data traffic to the application via a secure communication tunnel that is specific to the tenant between the communication delegate and the on-premise network of the tenant.

Certain aspects of the present disclosure are also directed to establishing the secure communication tunnel specific to the tenant. In some examples, the secure communication tunnel may include a first communication tunnel and a second communication tunnel. Establishing the secure communication tunnel specific to the tenant may include forming the first communication tunnel between the communication delegate mapped to the tenant and a midway server, and forming the second communication tunnel between a remote communication agent linked to the application hosted at the on-premise network of the tenant and the midway server. Once established, the secure communication tunnel may be exposed to the tenant as a unique Uniform Resource Locator (URL) that can be accessed by the tenant users corresponding to the tenant.

As will be appreciated, in some examples, the cloud platform proposed herein enables secure communication between the cloud platform and the application running on the on-premise network of the tenant. This is achieved at least in part by communicating the encrypted data traffic over the secure communication tunnel that is specific to the tenant. Further, in some examples, the secure communication tunnel is established between a communication delegate that is uniquely mapped to the tenant and remote communication agent associated with the application. In particular, the cloud platform includes a separate communication delegate mapped to each tenant of the tenants of the cloud platform. Use of the individual communication delegates for each of the tenants may provide multi-tenancy support while ensuring secure communication. Moreover, the communication delegate may have its respective unique certificate configured with the identifier of the communication delegate and the IP address associated with the communication delegate. These parameters contained in the unique certificate may be used to establish a trust at the midway server that the encrypted data traffic is coming from an authorized communication delegate thereby enhancing data security.

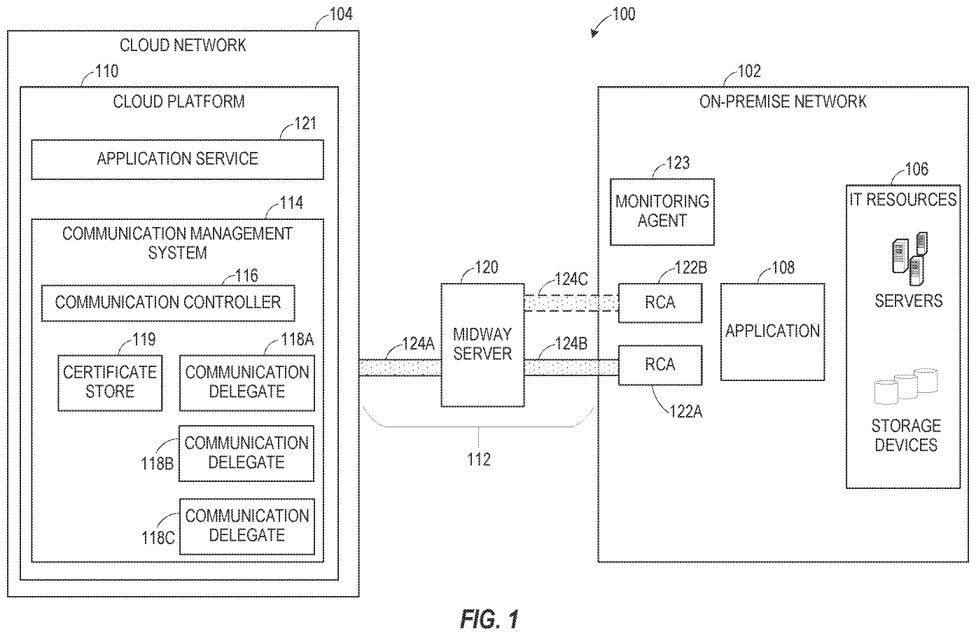

Referring now to the drawings, in FIG. 1, a networked system 100 is presented, in accordance with an example. As depicted in FIG. 1, in some examples, the networked system 100 may include an on-premise private network 102 (also referred to as an on-premise network 102) and a cloud network 104. The term “on-premise” may be understood to mean, for example, on location at premises (e.g., real estate, such as a data center) owned (fully or partially), operated, or subscribed by an entity or at a colocation center rented to the entity. Accordingly, the on-premise network 102 is hereinafter referred to as on-premise network 102 of the entity. Further, the term ‘entity’ as used herein may refer to an individual or an organization having one or more users (e.g., owners, employees, contractors, or administrators). The entity to which the on-premise network 102 belongs to is hereinafter referred to as a first entity.

The on-premise network 102 may be a data center including a network of IT resources 106 hosted on-premise. Examples of the IT resources 106 hosted in the on-premise network 102 may include, but are not limited to, servers, storage devices, network switches, routers, mobile communication devices, desktop computers, portable computers, computing system resource enclosures, or wireless local area network (WLAN) access points (some of which are depicted in FIG. 1). The servers may be blade servers, for example. The storage devices may be storage blades or storage arrays, for example. Further, in some examples, the computing system enclosures may be a blade enclosure housing one or more blades (e.g., blade servers, storage blades, etc.). One or more of the IT resources 106 may allow applications (e.g., an application 108) and/or application management platforms (e.g., a container management platform, a VM management system, Machine-learning platforms, and the like, not shown) to run thereon. Such applications running on the IT resources 106 of the on-premise network 102 are also alternatively referred as on-premise applications. The on-premise applications, which may provide services and functions, and application management platforms may run on the IT resources, which store data.

The on-premise application 108 may include any software including a set of instructions executable by a processor. Examples of the on-premise application 108 may include, but are not limited to, a virtual machine (VM), a container, a containerized application, a pod, or a machine-learning (ML) application. By way of example, the ML application may allow an authorized user to perform various ML operations, including, but not limited to, building, training, deploying, or monitoring of one or more ML models. It is to be noted that the present disclosure is not limited with respect to a particular type of the on-premise application 108, use of the on-premise application 108, functionalities, and/or features offered by the on-premise application 108. For the purpose of illustration, the on-premise application 108 is described as being a VM. The on-premise applications may be managed (created, deployed, controlled, terminated, etc.) using respective application management platforms hosted on the on-premise network 102. For example, the applications such as VMs may be managed via VM management platforms. Further, an application management platform may provide flexibility to deploy and manage the applications (e.g., the on-premise application 108) at scale on any infrastructure, for example, on one or more of the IT resources 106, colocation facilities, multiple public clouds, or at the edge.

In some examples, communication to and from the on-premise application 108 may be enabled via one or more remote communication agents (RCAs), for example, RCAs 122A and 122B, one of which may be active at any given time and another may remain stand-by. For the purpose of illustration hereinafter, the remote communication agent (RCA) 122A is described as being operated as an active RCA whereas the RCA 122B may be operated as a standby RCA. In some example, the RCA 122A, 122B may be implemented as a software resource (for example, a VM, a container, a containerized application, or a pod executing on one or more of the IT resources 106) or a hardware resource that is capable of or configured to communicate with the on-premise application 108. For example, one or both of the RCAs 122A, 122B may be linked to the on-premise application 108 by allocating an IP address and a port associated with the on-premise application 108 to the RCAs 122A and 122B.

Further, in some examples, the on-premise network 102 may include a monitoring agent 123 hosted on one or more of the IT resources 106. In some example, the monitoring agent 123 may be implemented as a software resource (for example, a VM, a container, a containerized application, or a pod executing on one or more of the IT resources 106) or a hardware resource that is capable of or configured to monitor the RCAs 122A and 122B. The monitoring agent 123 may monitor the RCAs 122A, 122B for any failure. For example, if the RCA 122A is identified to have a failure or stops functioning, the monitoring agent 123 may restart the RCA 122A. In case the RCA 122A cannot be restarted, the monitoring agent 123 may generate a first alert. Similarly, if the RCA 122B is identified to have a failure or stops functioning, the monitoring agent 123 may restart the RCA 122B. In case the RCA 122B cannot be restarted, the monitoring agent 123 may generate a second alert. The first alert and/or the second alert may be issued to the administrator (or any other relevant user or system) via one or more messaging techniques, including but not limited to, displaying an alert message on a display, via a text message such as a short message service (SMS), a Multimedia Messaging Service (MMS), and/or an email, via an audio alarm, video, or an audio-visual alarm, a phone call, etc. without limiting the scope of the present disclosure.

The cloud network 104 may be a public cloud network which may include a network of IT resources (similar to the IT resources 106, for example) that are interconnected via the Internet, collocated at a common place or distributed among several locations. The cloud network 104 is external to the on-premise network 102. The services, for example, storage, compute, and/or networking capabilities offered by the IT resources of the cloud network 104 and/or the on-premise network 102 may be accessed by authorized users of the cloud network 104 via a cloud platform system, hereinafter referred to as cloud platform 110, hosted on the cloud network 104. The cloud platform 110 may provide its tenants a cloud-like experience by allowing management and/or usage of capabilities such as, for example, information technology (IT) infrastructure and/or services offered by respective on-premise networks in a pay-per-use model. The term ‘tenant’ of the cloud platform 110 as used herein may refer to an entity that is enrolled/registered with the cloud platform 110 to avail services offered by the cloud platform 110. There may be one or more users associated with the entity that is registered with the cloud platform 110 as the tenant. Accordingly, the users associated with the entity that is registered with the cloud platform 110 as the tenant are hereinafter referred to as tenant users. In some examples, all of the tenant users associated with a given tenant may share same subscription or access privileges for a given on-premise application. In certain other examples, the tenant users associated with the given tenant may have different subscription or access privileges among them for the given on-premise application. In the description hereinafter, services offered by the cloud platform 110 are described with reference to single on-premise network 102 associated with the first entity that is registered with the cloud platform 110 as a first tenant. Therefore, the term “first tenant user” refers to a user associated with the first entity.

Accordingly, in some examples, the first tenant users, depending on respective access privileges, can access one or more of several applications including but not limited to VMs, containers, pods, machine-learning operations, data storage, compute, virtual networking, or the like, hosted on the on-premise network 102 of the entity as services via the cloud platform 110 in a pay-per-use model. In a similar fashion, the cloud platform 110 may provide a cloud-like experience to a plurality of its tenants (e.g., registered entities with the cloud platform 110) to use applications and/or services hosted on respective on-premise networks on a pay-per-use basis, for example. In some examples, the IT resources 106 may either be managed by the first entity itself or a third-party organization via a management platform such as the cloud platform 110. In certain examples, the IT resources 106 may be owned and/or managed by the third-party organization, although the IT resources 106 are deployed in the on-premise network of the first entity to provide enhanced security as implemented by the entity's IT policies and data security norms while providing the cloud-like experience.

The management and/or consumption of the IT resources 106, the on-premise application management platforms, and the on-premise applications, the on-premise data, and the on-premise services offered by the on-premise network 102 may be facilitated in a cloud-like manner via the cloud platform 110 to the first tenant users everywhere one needs. In some examples, the cloud platform 110 may enable management and/or consumption of such capabilities of the on-premise network 102 as-a-service in a pay-per-use model at the edge, in colocations, and in a data center. Using the cloud platform 110, the first tenant users can use the on-premise applications (e.g., the on-premise application 108) hosted on the on-premise network 102, rapidly deploy the on-premise services, gain cost and compliance insights, and simplify management across of IT infrastructure of the on-premise network 102. Various examples of the on-premise services and/or public cloud services managed by the cloud platform 110, in the pay-per-use model, may include, but are not limited to, containers, virtual machines, bare metal, machine learning, database platform, private cloud, SAP HANA® produced by SAP SE, data protection, networking, storage, compute, and high-performance compute. The first tenant user can run various workloads using the foregoing example applications.

In some examples, communication between the cloud platform 110 and the on-premise networks associated with various tenants may be secured with the use of secure communication tunnels specific to each tenant. The term “secure communication tunnel” as used herein may refer to a secure communication channel established via protocols or techniques such as, but not limited to, one or more of Hyper Text Transfer Protocol Secure (HTTPS), Transport Layer Security (TLS) (e.g., TLS version 1.2), Internet Protocol Security (IPSec), Secure Shell (SSH), TLS over IPsec, SSH over IPsec. For example, the cloud platform 110 may communicate with the on-premise network 102 over a secure communication tunnel 112 that is specific to (i.e., exclusive to) the first tenant to which the on-premise network 102 belongs. Accordingly, the cloud platform 110 may communicate with other on-premise networks over respective separate secure communication tunnels specific to the respective tenants. In some examples, the secure communication tunnel 112 may be mapped to a unique URL which may be accessible by the first tenant. In particular, the secure communication tunnel 112 may be mapped to an application service 121 hosted on the cloud platform 110. In one example, the application service 121 may be a Kubernetes service. The application service 121 may create an ingress which is an external end point as the unique URL. In particular, the first tenant users can open the unique URL via a web-browser or via a mobile application and can access the on-premise application 108 for various management operations thereon upon successful authentication.

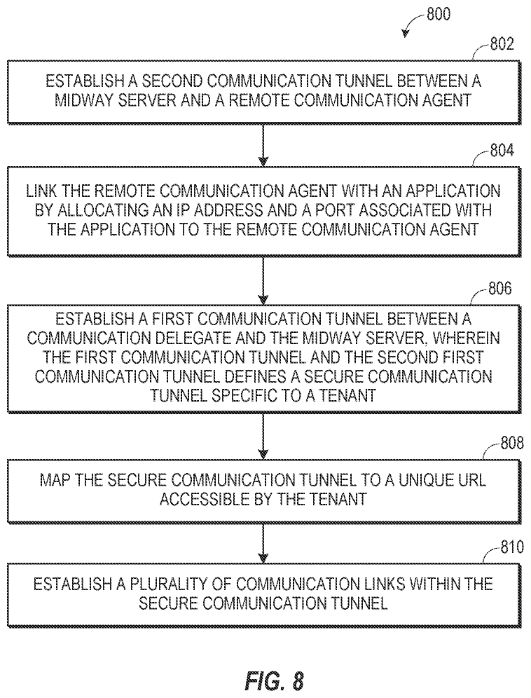

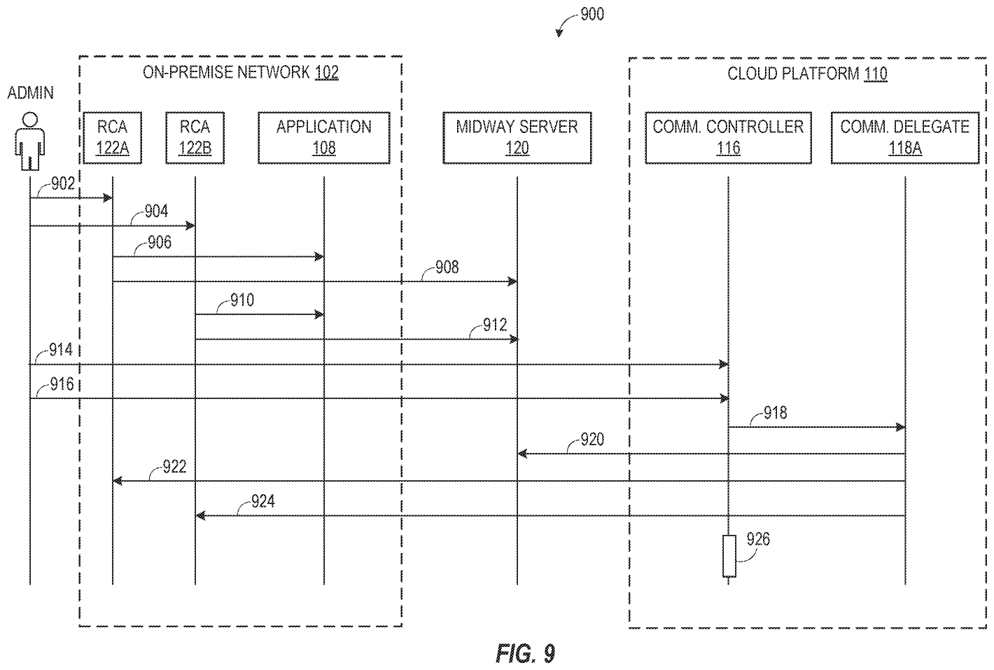

Details of establishing the secure communication tunnel 112 are described in conjunction with FIGS. 8 and 9. Further, to enable such secure communication with the on-premise network 102, in some examples, the cloud platform 110 may include a communication management system 114. The communication management system 114 may receive data traffic and direct the data traffic to respective destination, for example, respective on-premise network via a secure communication tunnel specific to a tenant associated with the data traffic.

To effect such secure routing of the data traffic to its respective destination, the communication management system 114 may include a communication controller 116 and a plurality of communication delegates 118A, 118B, and 118C (hereinafter collectively referred to as communication delegates 118A-118C). In FIG. 1, the communication management system 114 is shown to include three communication delegates 118A-118C, for illustration purposes. In some examples, the communication management system 114 may include a separate communication delegate corresponding each of a plurality of tenants of the cloud platform 110. In particular, each of the communication delegates 118A-118C may be mapped to a unique tenant of the plurality of tenants of the cloud platform 110.

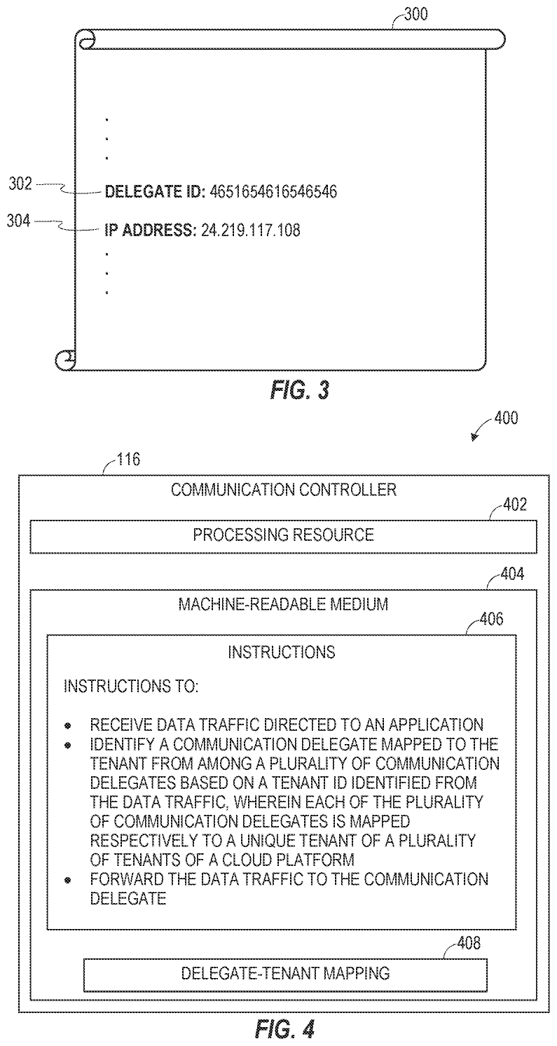

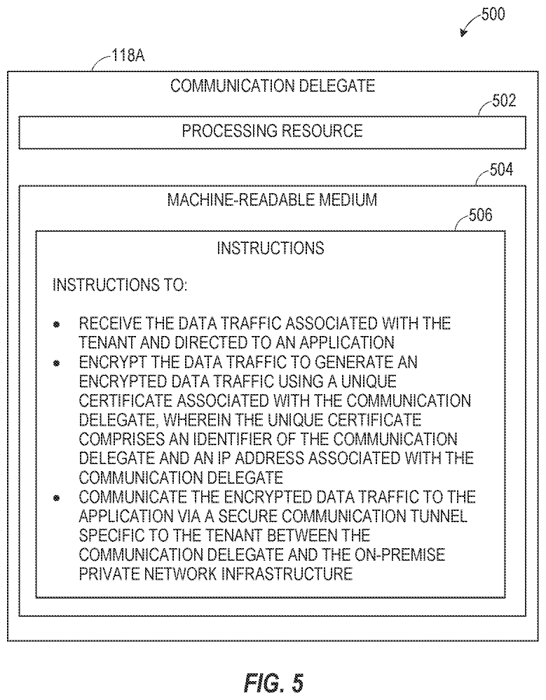

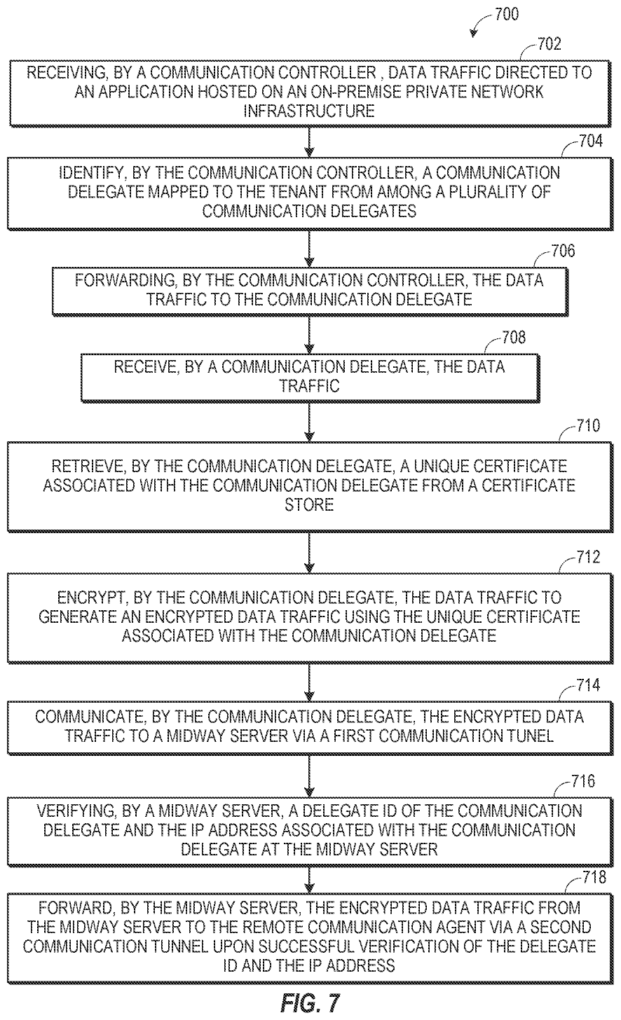

In the description hereafter, for illustration purposes, the communication delegate 118A is described as a communication delegate that is mapped to the first tenant of the cloud platform 110. The communication delegates 118B and 118C may be mapped to respective ones of other tenants (e.g., a second tenant and a third tenant, respectively) of the cloud platform 110. The tenants mapped to communication delegates 118B and 118C may have respective on-premise networks (not shown). Details regarding configuration of the communication controller 116 and operations performed by the communication controller 116 are described on conjunction with FIGS. 4 and 7. Further, details regarding configuration of the communication delegate 118A and operations performed by the communication delegate 118A are described on conjunction with FIGS. 5-7. Other communication delegates 118B, 118C are understood to have similar configuration as that of the communication delegate 118A and may perform similar operations as that of the communication delegate 118A corresponding to respective data traffic directed to respective tenants.

Each of the plurality of communication delegates 118A-118C may securely communicate with an on-premise network associated with a respective tenant via a secure communication tunnel that is specific to the respective tenant. In particular, for illustration purposes, one such secure communication tunnel 112 is depicted in FIG. 1 that is specific to the first tenant and through which the communication delegate 118A mapped to the first tenant may communicate with the on-premise network 102. Similarly, the other communication delegates 118B and 118C may communicate with respective on-premise networks (not shown) via respective separate secure communication tunnels (not shown) that are specific to the respective tenants (e.g., the second tenant and the third tenant, respectively).

In some examples, the secure communication tunnels between one or more of the communication delegates 118A-118C and respective on-premise networks may be established through a common midway server, such as, a midway server 120. In certain other examples, the secure communication tunnels of one or more of communication delegates 118A-118C may be established via one midway server (e.g., the midway server 120), whereas the secure communication tunnels associated with certain other communication delegates may be established via another midway server (not shown). Examples of the midway server 120 may include, but are not limited to, a desktop computer, a laptop, a mobile device, a blade server, a computer appliance, a workstation, a storage system, or a converged or a hyperconverged system, or the like. In the description hereinafter, references will be made the secure communication tunnel 112 between the communication delegate 118A and the on-premise network 102 that is specific to the first tenant. The secure communication tunnels between the other communication delegates 118B, 118C and the respective on-premise networks may have similar features and may be established in a similar fashion as described with reference to the secure communication tunnel 112.

In some examples, the secure communication tunnel 112 may include a first communication tunnel 124A and a second communication tunnel 124B. The first communication tunnel 124A may be a secure communication channel between the communication delegate 118A and the midway server 120. Similarly, the second communication tunnel 124B may be a secure communication channel between the midway server 120 and the RCA 122A hosted at the on-premise network 102. In certain examples, the secure communication tunnel 112 may include a standby communication tunnel 124C that may be a secure communication channel between the midway server 120 and the RCA 122B (which may be in a standby mode). Additionally, in some examples, to enhance speed of data transfer and load balancing within the secure communication tunnel 112, a plurality of communication links may be operationalized within the secure communication tunnel 112. In some examples, one or more of the first communication tunnel 124A, the second communication tunnel 124B, or the standby communication tunnel 124C may be a secure communication channel established according to one or more of HTTPS, TLS, IPSec, SSH, TLS over IPsec, or SSH over IPsec techniques. In some examples, one or more of the first communication tunnel 124A, the second communication tunnel 124B, or the standby communication tunnel 124C may be formed on-demand, remain persistent, or scheduled and may enable unidirectional communications or bi-directional communications. For example, the data traffic from originated from the on-premise application 108 may be sent to the cloud platform 110 through the secure communication tunnel 112.

During operation, the first tenant user may login to the cloud platform 110 and may perform one or more operations pertaining to the on-premise application 108 or using the on-premise application 108. In some examples, actions performed by the first tenant user may generate data traffic directed to the on-premise application 108. The actions performed may include, but are not limited to, adding new applications, removing the on-premise application 108, modifying the on-premise application 108, accessing the on-premise application 108, updating user access for the on-premise application 108, and the like. It is to be noted that the scope of the present disclosure is not limited with respect to types of operations performed by the tenant user. The term “data traffic” as used herein may refer to any data that is generated in response to the tenant user performing any action and/or any automated action (e.g., monitoring of resource usages, performance checks, automated updates, or any scheduled or event driven actions) performed via the cloud platform 110.

The communication controller 116 may direct the data traffic to a communication delegate, from the plurality of communication delegates, that is mapped to the tenant associated with the data traffic. For example, if the data traffic is generated due to any action performed by the first tenant user associated with the tenant, the communication controller 116 may direct the data traffic to the communication delegate 118A mapped to the first tenant. Accordingly, the communication delegate 118A may receive the data traffic. The communication delegate 118A may encrypt the data traffic to generate an encrypted data traffic using a unique certificate associated with the communication delegate 118A and communicate the encrypted data traffic to the on-premise application 108 via the secure communication tunnel 112 that is specific to the first tenant. In some examples, the unique certificate may include an identifier of the communication delegate 118A and an IP address associated with the communication delegate. An example unique certificate associated with the communication delegate 118A is depicted in FIG. 3.

In some examples, the communication management system 114 may include a certificate store 119. The certificate store 119 represent a repository of data, for example, a repository that stores unique certificates corresponding to each of the communication delegates 118A-118C. In some examples, the unique certificate associated with the communication delegate 118A may be stored in the certificate store 119. The unique certificate associated with the communication delegate 118A may be retrieved by the communication delegate 118A to encrypt the data traffic.

In some examples, the communication controller 116, during operation, may monitor the communication delegate 118A to keep a check on failure of any of a first plurality of communication links established in the secure communication tunnel 112 between the communication delegate 118A and the active RCA 122A. In case failure of any communication links of the first plurality of communication links is detected, the communication controller 116 may reestablish the failed communication link. In case a threshold number (or more) of the first plurality of communication links are found broken, the communication controller 116 may switch the secure communication tunnel 112 to the standby RCA 122B. In such situation, the secure communication tunnel 112 may be formed of the first communication tunnel 124A and the standby communication tunnel 124C. In some examples, the threshold number may be determined based on a predefined data transfer bandwidth. For example, the threshold number may represent a number of communication links that are useful to achieve the predefined data transfer bandwidth. In certain other examples, the threshold number may be same as a number of communication links in the first plurality of communication links.

As will be appreciated, in some examples, the cloud platform 110 proposed herein enables secure communication between the cloud platform 110 and the on-premise application 108 running on the on-premise network 102 of the first tenant. This is achieved at least in part by communicating the encrypted data traffic over the secure communication tunnel 112 that is specific to the first tenant. Further, in some examples, the secure communication tunnel 112 is established between the communication delegate 118A that is uniquely mapped to the first tenant. In particular, the cloud platform 110 includes separate communication delegate for each of the tenants of the cloud platform 110. Use of the individual communication delegates for each of the tenants may provide multi-tenancy support while ensuring secure communication. Moreover, the communication delegate 118A may have its respective unique certificate 300 configured with the delegate ID 302 and the IP address 304 associated with the communication delegate 118A. These parameters contained in the unique certificate 300 may be used to establish a trust at the midway server 120 to ensure that the encrypted data traffic is coming from an authorized communication delegate thereby enhancing data security and ensuring that secure communication tunnel 112 does not interfere with secure communication tunnels associated with other tenants (not shown).

Furthermore, in some examples, the secure communication tunnel 112 proposed herein is highly-available as it is monitored continuously for any failures. More particularly, in a situation when the first RCA 122A fails and the second communication tunnel 124B is broken, the secure communication tunnel 112 may remain stable as the RCA 122B may be made active and the second communication tunnel 124B may be made operational. Further, the administrator may be alerted by the monitoring agent 123 in case of failure of one or more of the RCAs 122A, 122B so that the administrator can take relevant corrective actions. Additionally, use of the plurality of communication links within the secure communication tunnel 112 may enhance speed of data transfer and load balancing within the secure communication tunnel 112.

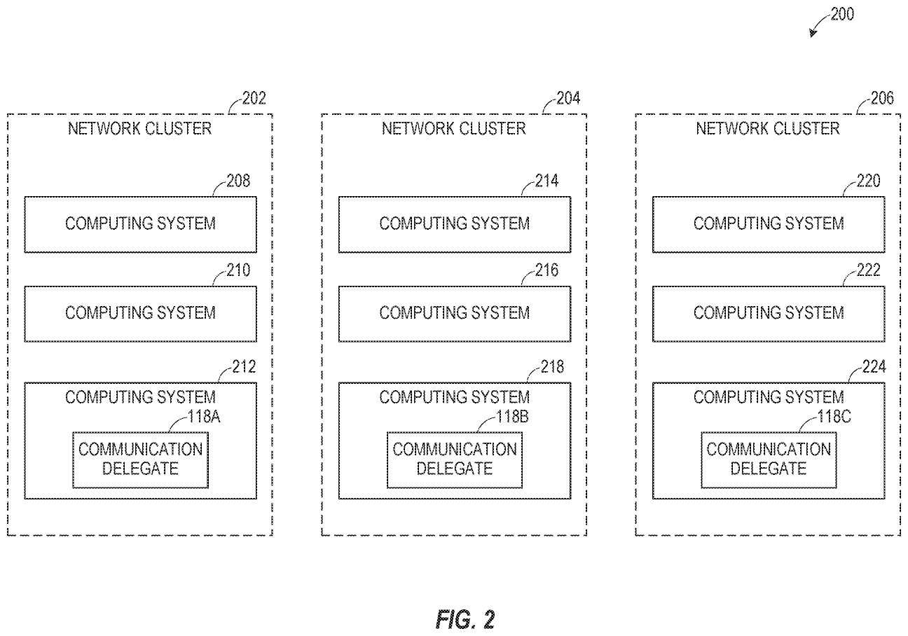

Referring now to FIG. 2, a portion 200 of a cloud network 104 is presented, in accordance with an example. In some examples, the portion 200 of the cloud network 104 depicted in FIG. 2 may include one or more network clusters, such as, network clusters 202, 204, and 206 each of which may be uniquely reachable via respective IP addresses. In FIG. 2, three network clusters 202-206 are depicted for illustration purposes. In some examples, the cloud network 104 may include any number of network clusters, without limiting the scope of the present application. As depicted in FIG. 2, each of the network cluster may include a network of one or more computing systems, for example computing systems 208, 210, 212, 214, 216, 218, 220, 222, or 224 (hereinafter collectively referred to as computing systems 208-224). In the example of FIG. 2, the network cluster 202 is shown to include computing systems 208, 210, and 212; the network cluster 204 is shown to include computing systems 214, 216, and 218; and the network cluster 204 is shown to include computing systems 220, 222, and 224. It is to be noted that the network clusters 202-206 may include same or different number of computing systems. Also, the scope of the present disclosure is not limited with reference to the number of computing systems that can be included in each of the network clusters 202-206. Examples of the computing systems 208-224 may include, but are not limited to, desktop computers, laptops, mobile devices, servers, computer appliances, workstations, storage systems, or converged or hyperconverged systems, or the like. Further, in some examples, the network cluster 202-208 may be coupled to each other via a network (not shown).

In some examples, the network clusters 202-206 may be Kubernetes clusters. In such an implementation, in a given network cluster of the network clusters 202-206, one computing system may act as a master node (also referred to as a management node) and the rest of the computing systems may operate as worker nodes (also referred to as member nodes). The master node may run container management platform to manage deployment, monitoring, and/or migration of workloads on the worker nodes in the given cluster. For purpose of illustration, the computing systems 208, 214, and 220 may be operated as management nodes in the network clusters 202, 204, and 206, respectively. Whereas, the rest of the computing systems 210, 212, 216, 218, 222, and 224 may be configured to be operated as worker nodes that may provide resources (e.g., compute, storage, networking, etc.) for execution of workloads running thereon.

In some examples, the communication delegates 118A-118C may be deployed on one or more of the network clusters 204-206 as workloads (in the form of containers or pods). For illustration purposes, the communication delegates 118A, 118B, and 118C are shown as deployed on the network clusters 202, 204, and 206, respectively. For example, the communication delegates 118A, 118B, and 118C may be respectively deployed on the computing systems 212, 218, and 224 as containers or pods. In some examples, all of the communication delegates 118A, 118B, and 118C may be deployed in a common network cluster. In certain other examples, the communication delegates 118A, 118B, and 118C may be distributed (e.g., as depicted in FIG. 2) among two or more of the network clusters 202-206. In some examples, although not depicted in FIG. 2, the communication controller 116 and the certificate store 119 may also be hosted on the worker nodes of one or more of the network clusters 202-206.

Moving now to FIG. 3, a unique certificate 300 associated with the communication delegate 118A is depicted, in accordance with an example. An example of the unique certificate 300 may include a digital certificate that uses widely accepted international X.509 public key infrastructure (PKI) standard to verify that a public key belongs to the tenant identified in the certificate 300. In some examples, the unique certificate associated with a given communication delegate may include, among other information, an identifier of the given communication delegate (hereinafter referred to as a delegate ID) and an IP address associated with the given communication delegate. The delegate ID may represent a unique identifier of the given communication delegate. The IP address associated with the given communication delegate may include an IP address of a cluster of the one or more network clusters 202-208 that hosts the given communication delegate. In the example of FIG. 3, the unique certificate 300 associated with the communication delegate 118A is shown to include a delegate ID 302 of the communication delegate 118A and an IP address 304 associated with the communication delegate 118A. The IP address 304 represents an IP address of the network cluster 202 hosting the communication delegate 118A. Further, the delegate ID 302 may be a unique combination of one or more of numbers, letters, or symbols. For example, in FIG. 3, the certificate 300 is shown to include the delegate ID 302 having an example value of “4651654616546546” and the IP address 304 having example value of 24.219.117.108. The values of the delegate ID 302 and the IP address 304 depicted in FIG. 3 are for example purposes only, any resemblance of these values with other IDs or IP addresses may be a mere coincidence.

In certain other examples, although not depicted in FIG. 3, the certificate 300 may include additional information including, but not limited to, a version number of the certificate 300, a serial number of the certificate 300, a signature algorithm ID of the certificate 300, a name of an issuer of the certificate 300, a validity period of the certificate 300, a name of the communication delegate (e.g., the communication delegate 118A), public key information of the communication delegate 118A, a public key algorithm, a public key of the communication delegate 118A, a unique ID of the issuer of the certificate 300, a signature algorithm of the certificate 300, a signature of the certificate 300, or any combination of the foregoing. In some examples, the certificate 300 may be signed by a trusted certificate authority or may be validated by other means. Accordingly, someone holding the certificate 300 can rely on the public key contained in the certificate 300 to establish secure communications with another party, or validate documents or data digitally signed/encrypted by the corresponding private key.

Turning now to FIG. 4, a block diagram 400 depicting the communication controller 116 of the communication management system 114 (see FIG. 1) is presented, in accordance with an example. In some examples, the communication controller 116 may be a processor-based system that performs various operations to direct data traffic to respective communication delegate of the communication delegates 118A-118C in the cloud platform 110 of FIG. 1. In some examples, the communication controller 116 may be a device including a processor or a microcontroller and/or any other electronic component, or a device or system that may facilitate various compute, data storage, and/or data processing, for example. In certain other examples, the communication controller 116 may be deployed as a software resource, for example, a VM, a container, a containerized application, or a pod executing on one or more of the IT resources hosted in the cloud network 104. In some examples, the communication controller 116 may be deployed as the software resource in one or more of the network clusters 202-206.

In some examples, the communication controller 116 may include a processing resource 402 and a machine-readable medium 404. The machine-readable medium 404 may be any electronic, magnetic, optical, or other physical storage device that may store data and/or executable instructions 406. For example, the machine-readable medium 404 may include one or more of a Random Access Memory (RAM), an Electrically Erasable Programmable Read-Only Memory (EEPROM), a storage drive, a flash memory, a Compact Disc Read Only Memory (CD-ROM), and the like. The machine-readable medium 404 may be non-transitory. As described in detail herein, the machine-readable medium 404 may be encoded with the executable instructions 406 to perform operations at one or more blocks of a method described in FIG. 7 (described later).

Further, the processing resource 402 may be a physical device, for example, one or more central processing unit (CPU), one or more semiconductor-based microprocessors, one or more graphics processing unit (GPU), application-specific integrated circuit (ASIC), a field programmable gate array (FPGA), other hardware devices capable of retrieving and executing instructions 406 stored in the machine-readable medium 404, or combinations thereof. The processing resource 402 may fetch, decode, and execute the instructions 406 stored in the machine-readable medium 404 to direct data traffic to respective communication delegate of the communication delegates 118A-118C. As an alternative or in addition to executing the instructions 406, the processing resource 402 may include at least one integrated circuit (IC), control logic, electronic circuits, or combinations thereof that include a number of electronic components for performing the functionalities intended to be performed by the communication controller 116. Moreover, in certain examples, where the communication controller 116 is implemented as the software resource, the processing resource 402 and the machine-readable medium 404 may represent a processing resource and a machine-readable medium of a hardware or a computing system that hosts the communication controller 116 as the software resource.

In some examples, the machine-readable medium 404 may also include a delegate-tenant mapping 408. The delegate-tenant mapping 408 may include a mapping between the tenants of the cloud platform 110 and communication delegates 118A-118C. Each of the tenants of the cloud platform 110 may be assigned a unique tenant identifier (ID) which may be a unique combination of one or more of numbers, letters, or symbols. Accordingly, the delegate-tenant mapping 408 may include mapping between the tenant IDs and communication delegates 118A-118C. In one example, if the tenant IDs corresponding to the first tenant, the second tenant, and the third tenant are 1234, 1235, 1236, respectively, Table-1 depicted below may represent an example delegate-tenant mapping 408. As previously noted, the first tenant is associated with the on-premise network 102 hosting the on-premise application 108.

TABLE 1
Example delegate-tenant mapping 408

| Tenant ID | Communication Delegate |
|---|---|
| 1234 | Communication delegate 118A |
| 1235 | Communication delegate 118B |
| 1236 | Communication delegate 118C |

In certain examples, the communication controller 116 may allow an administrator to define one or more additional tenant IDs upon onboarding of new tenants and allocate respective communication delegates and update the delegate-tenant mapping 408 to include respective entries. Although, the content of the delegate-tenant mapping 408 is shown in the form of a table (e.g., Table-1), the content of the delegate-tenant mapping 408 may be stored in any suitable form including but not limited to, a syntax or a script. The delegate-tenant mapping 408 may be referenced by the processing resource 402 to identify a communication delegate corresponding to a tenant ID identified from a data traffic. The communication controller 116 may then forward the data traffic to the identified communication delegate. Details regarding the operations performed by the communication controller 116 are described on conjunction with a method depicted in FIG. 7.

Turning now to FIG. 5, a block diagram 500 depicting a communication delegate, such as, the communication delegate 118A is presented, in accordance with an example. In some examples, the communication delegate 118A may be a processor-based system that performs various operations to communicate the data traffic from the cloud platform 110 hosted on the cloud network 104 to the on-premise application 108 hosted on the on-premise network 102. In some examples, the communication delegate 118A may be a device including a processor or a microcontroller and/or any other electronic component, or a device or system that may facilitate various compute, data storage, and/or data processing, for example. In certain other examples, the communication delegate 118A may be deployed as a software resource, for example, a VM, a container, a containerized application, or a pod executing on one or more of the IT resources hosted in the cloud network 104. In some examples, as depicted in FIG. 2, the communication delegate 118A may be deployed as the software resource in one or more of the network clusters 202-206.

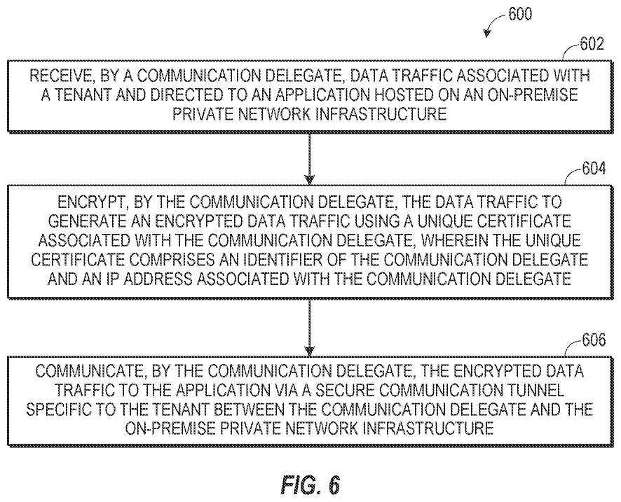

In some examples, the communication delegate 118A may include a processing resource 502 and a machine-readable medium 504. The machine-readable medium 504 may be non-transitory and is representative of one example of the machine-readable medium 404. Further, the machine-readable medium 504 may include one or more example devices as that of the machine-readable medium 404. As described in detail herein, the machine-readable medium 504 may be encoded with the executable instructions 506 to perform operations at one or more blocks of methods described in FIGS. 6 and 7 (described later). Further, the processing resource 502 may be representative of one example of the processing resource 402 and may include one or more example devices as that of the processing resource 402. The processing resource 502 may fetch, decode, and execute the instructions 506 stored in the machine-readable medium 504 to communicate the data traffic from the cloud platform 110 hosted on the cloud network 104 to the on-premise application 108 hosted on the on-premise network 102. As an alternative or in addition to executing the instructions 506, the processing resource 502 may include at least one integrated circuit (IC), control logic, electronic circuits, or combinations thereof that include a number of electronic components for performing the functionalities intended to be performed by the communication delegate 118A. Moreover, in certain examples, where the communication delegate 118A is implemented as the software resource, the processing resource 502 and the machine-readable medium 504 may represent a processing resource and a machine-readable medium of a hardware or a computing system that hosts the communication delegate 118A as the software resource.

In the description hereinafter, several operations performed by the communication controller 116 or the communication delegate 118A will be described with help of flow diagrams depicted in FIGS. 6-7. For illustration purposes, the flow diagrams depicted in FIGS. 6-7 are described in conjunction with the networked system 100 of FIG. 1 and the block diagram 400 and 500 of FIGS. 4-5, however, the methods of FIG. 6-7 should not be construed to be limited to the example configuration of networked system 100 (e.g., with respect to quantity of on-premise network, communication delegates, etc.). The methods described in FIGS. 6-7 include a plurality of blocks, operations at which may be performed by a processor-based system such as, for example, any of the communication controller 116 or the communication delegate 118A. In particular, operations at each of the plurality of blocks may be performed by the respective processing resource 402 or 502 by executing one or more of the instructions 406, 506, respectively stored in the machine-readable mediums 404, 504. In particular, the methods described in FIGS. 6-7 may represent an example logical flow of some of the several operations performed by the communication controller 116 or the communication delegate 118A. However, in some other examples, the order of execution of the blocks depicted in FIGS. 6-7 may be different than the order shown. For example, the operations at various blocks may be performed in series, in parallel, or a series-parallel combination.

Referring now to FIG. 6, a flow diagram of a method 600 for providing secure communication between the on-premise application 108 hosted on the on-premise network 102 and the cloud platform 110 is presented, in accordance with an example. The method 600 may include blocks 602, 604, and 606 that are performed by the communication delegate 118A. In some examples, operations at blocks 602, 604, and 606 may be performed by the processing resource 502 by executing one or more of the instructions 506 stored in the machine-readable medium 504.

At block 602, the communication delegate 118A may receive the data traffic associated with a tenant, in particular, the first tenant, and directed to the on-premise application 108 hosted on the on-premise network 102 of the first tenant. The data traffic is forwarded to the communication delegate 118A by the communication controller 116. Details of forwarding the data traffic to the communication delegate 118A by the communication controller 116 are described in FIG. 7.

Further, at block 604, the communication delegate 118A may encrypt the data traffic to generate an encrypted data traffic using a unique certificate (e.g., the certificate 300) associated with the communication delegate 118A. In some examples, communication delegate 118A may implement one or more encryption techniques (e.g., encryption using public key cryptography and digital certificates such as the X.509 certificates). In some examples, the encryption of the data traffic may include linking the data traffic to the unique certificate of the communication delegate. For example, the communication delegate 118A may link the unique certificate 300 with the data traffic received from the communication controller 116 so that the recipient (e.g., the midway server 120 or the on-premise application 108) of the encrypted data traffic can verify the identity of the communication delegate 118A. Only the communication delegate 118A may be in possession of a private key associated with the public key listed in the certificate 300. Accordingly, in some examples, the communication delegate 118A may encrypt (e.g., sign) the data traffic using the private key. The recipient can validate the encrypted data traffic using the public key contained in the unique certificate 300.

Moreover, at block 606, the communication delegate 118A may communicate the encrypted data traffic to the on-premise application 108 via the secure communication tunnel 112 that is specific to the first tenant. Details regarding the transmission of the encrypted data traffic over the secure communication tunnel 112 is described in conjunction with FIG. 7.

Moving now to FIG. 7, a detailed flow diagram of a method 700 for providing secure communication between the on-premise application 108 hosted on the on-premise network 102 and the cloud platform 110 is presented, in accordance with an example. The method 700 may include blocks 702, 704, 706, 708, 710, 712, 714, 716, and 718. Amongst these blocks, operations at blocks 702, 704, and 706 may be performed by the communication controller 116. Further, operations at blocks 708, 710, 712, and 714 may be performed by the communication delegate 118A. Furthermore, operations at blocks 716 and 718 may be performed by the midway server 120.

At block 702, the communication controller 116 may receive data traffic. The data traffic may include information data and a unique identifier associated with a tenant (alternatively referred to as a tenant ID) associated with the tenant user that is logged-in while the data traffic is generated. In some examples, the communication controller 116 may identify/extract the tenant ID from the data traffic. For example, if the data traffic relates to the first tenant, the data traffic may include the tenant ID 1234. Accordingly, the communication controller 116 may extract the tenant ID 1234 from the data traffic. Further, at block 704, the communication controller 116 may identify a communication delegate mapped to the tenant from among the plurality of communication delegates 118A-118C based on the tenant ID. For example, the processing resource 402 may reference the delegate-tenant mapping 408 to identify a communication delegate corresponding to the tenant ID identified from the data traffic. For example, if the tenant ID identified from a data traffic is 1234, the processing resource 402 may identify the communication delegate 118A as the communication delegate mapped to the first tenant using the delegate-tenant mapping 408. Once the communication delegate mapped to the first tenant is identified, at block 706, the processing resource 402 may forward the data traffic to the communication delegate identified at block 704. For example, if the tenant ID identified from a data traffic is 1234, the processing resource 402 may forward the data traffic to the communication delegate 118A. Accordingly, at block 708, the data traffic may be received by the communication delegate 118A, for example.

Further, in some examples, at block 710, the communication delegate 118A may retrieve the unique certificate (e.g., the certificate 300) associated with the communication delegate 118A. For example, the communication delegate 118A may perform a search in the certificate store 119 using parameters including, but not limited to, delegate ID or the serial number of the certificate 300 and retrieve the matching certificate—that is the certificate 300 associated with the communication delegate 118A. Once retrieved, at block 712, the processing resource 502 may encrypt the data traffic to generate the encrypted data traffic using the certificate 300 in a similar fashion as described in conjunction with FIG. 6. Moreover, the processing resource 502 may communicate the encrypted data traffic to the on-premise application 108 via the secure communication tunnel 112 that is specific to the first tenant. As previously noted, the secure communication tunnel 112 is formed of two communication tunnels—the first communication tunnel 124A and the second communication tunnel 124B. In some examples, at block 714, the processing resource 502 may send the encrypted data traffic to the midway server 120 via the first communication tunnel 124A.

At block 716, the midway server 120 may verify a delegate ID and an IP address associated with the encrypted data traffic received at the midway server 120. The IP address associated with the encrypted data traffic may refer to an IP address contained appended with the encrypted data traffic indicative of a source address of the encrypted data traffic. The delegate ID associated with the encrypted data traffic may represent an identifier of a communication delegate from which the encrypted data traffic is received and may be appended with the encrypted data traffic received at the midway server 120. In particular, the midway server 120 may compare the IP address associated with the incoming encrypted data traffic with the IP address 304 stored in the certificate 300. Further, the midway server 120 may compare a delegate ID associated with the incoming encrypted data traffic with the delegate ID 302 stored in the certificate 300. In some examples, the midway server 120 may determine that the verification is successful if the delegate ID and IP address associated with the incoming encrypted data traffic matches with the delegate ID 302 and the IP address 304, respectively, contained in the certificate 300. In some examples, upon successful verification of the delegate ID and IP address, at block 718, the midway server 120 may forward the encrypted data traffic to the RCA 122A via the second communication tunnel 124B. The encrypted data traffic may then be communicated from the RCA 122A to the on-premise application 108 hosted on the on-premise network.

Turning now to FIG. 8, a flow diagram of a method 800 for establishing a secure communication tunnel, such as, the secure communication tunnel 112, is presented, in accordance with an example. In some examples, operations at various blocks 802, 804, 806, 808, and 810 of the method 800 may be performed during an onboarding phase of the first tenant with the cloud platform 110.

At block 802, the second communication tunnel 124B may be established between the midway server 120 and the RCA 122A. In particular, to establish the second communication tunnel 124B, the RCA 122A may be configured with the delegate ID 302 of the communication delegate 118A. Once configured with the delegate ID 302, the RCA 122A may be operationalized (i.e., is run/executed) so that the RCA 122A connects securely to the midway server 120 via a secure communication channel that is the second communication tunnel 124B. In some examples, the RCA 122A may be configured with the delegate ID 302 to ensure that RCA 122A accept the encrypted data traffic associated only with the delegate ID 302. Further, at block 804, the RCA 122A may be linked to the on-premise application 108 hosted at the on-premise network 102 by allocating an IP address and a port associated with the on-premise application 108 to the RCA 122A.

Further, at block 806, the first communication tunnel 124A may be established between communication delegate 118A and the midway server 120. In particular, to establish the first communication tunnel 124A, the communication delegate 118 may be mapped the RCA 122A based on one or more of the tenant ID, a time-bound token, and an identifier associated with a RCA 122A (hereinafter referred to as an agent ID) hosted at the on-premise network 102. Once configured, the communication delegate 118A may be operationalized (i.e., is run/executed) so that the communication delegate 118A securely connects to the midway server via a secure communication channel that is the first communication tunnel 124A. Upon establishing the first communication tunnel 124A and the second communication tunnel 124B, the secure communication tunnel 112 is said to be successfully established.

Furthermore, at block 808, the secure communication tunnel 112 may be mapped to a unique Uniform Resource Locator (URL) accessible by the first tenant. In some examples, authorized users of the first tenant (i.e., the first tenant users) can access the on-premise application 108 via the unique URL that is mapped to the secure communication tunnel 112. In particular, the first tenant users can open the unique URL via a web-browser or via an application and can access the application for various management operations thereon upon successful authentication. During operation, all data traffic corresponding to the tenant ID associated with the first tenant and directed to the on-premise application 108 may be transmitted through the secure communication tunnel 112 specific to the first tenant as described in conjunction with one or more of the previous drawings. Additionally, in some examples, to enhance speed of data transfer and load balancing within the secure communication tunnel 112, a plurality of communication links may be operationalized within the secure communication tunnel 112, as indicated by block 810. For example, multiple communication channels are mapped to the application service 121, which is in-turn mapped to the unique URL. The first tenant users can open this unique URL through browser and hence access the multiple communication channels to communicate with the on-premise application 108. Detailed sequence of operations performed to establish the secure communication tunnel 112 is described in conjunction with FIG. 9.

Moving now to FIG. 9, a sequence diagram 900 depicting example sequence of operations for setting-up the secure communication tunnel 112 between the communication delegate 118A and the on-premise network 102 is presented, in accordance with an example.

At operation 902, an administrator (labeled as ADMIN in FIG. 9) may install the RCA 122A on one of the IT resources 106 at the on-premise network 102 and configure the RCA 122A with the delegate ID 302 of the communication delegate 118A so that the RCA 122A can communicate with the communication delegate 118A. Similarly, at operation 904, the administrator may install the RCA 122B on one of the IT resources 106 and configure the RCA 122B with the delegate ID 302 of the communication delegate 118A so that the RCA 122B can communicate with the communication delegate 118A. Installation may be performed through an automated computer-based process, such as via scripts or the like. At operation 906, a communication path is established between the RCA 122A and the on-premise application 108 by linking a port and an IP address associated with the on-premise application 108 with the RCA 122A so that the RCA 122A can communicate data (e.g., the encrypted data traffic) to the on-premise application 108 or receive data from the on-premise application 108. Moreover, at operation 908, the RCA 122A is operationalized (i.e., is run/executed) so that it establishes a secure communication channel with the midway server 120. This secure connection channel between the RCA 122A and the midway server 120 is referred to as the second communication tunnel 124B. It may be noted that in some examples, the order of operations 906 and 908 may be reversed without limiting the scope of the present disclosure.

Further, in certain examples, at operation 910, a communication path is established between the RCA 122B and the on-premise application 108 by linking the port and the IP address associated with the on-premise application 108 with the RCA 122B so that the RCA 122B can communicate data (e.g., the encrypted data traffic) to the on-premise application 108 or receive data from the on-premise application 108. Moreover, at operation 912, the RCA 122B is operationalized (i.e., is run/executed) so that it establishes a secure communication channel with the midway server 120. This secure connection channel between the RCA 122B and the midway server 120 is referred to as the standby communication tunnel 124C. It may be noted that in some examples, the order of operations 906 and 908 may be reversed without limiting the scope of the present disclosure.

By now, the second communication tunnel 124B and the standby communication tunnel 124C have been established. In order to fully establish the secure communication tunnel 112, the communication controller 116 and the communication delegate 118A may be configured to map the communication delegate 118A with the RCA 122A and the RCA 122B. Accordingly, at operation 914, the administrator may provide an identifier of the RCA 122A (alternatively referred to as a station ID (SSID) of the RCA 122A), the tenant ID, and a time-bound token via a user interface (UI, not shown). The UI may call an application programming interface (API) that supplies the inputted information regarding the SSID of the RCA 122A, the tenant ID, and the time-bound token to the communication controller 116 hosted on the cloud platform 110. Similarly, at operation 916, the administrator may provide the SSID of the RCA 122B, the tenant ID, and a time-bound token (which may be different from the time-bound token used at operation 914) via the UI. The UI may call the API that supplies the inputted information regarding the SSID of the RCA 122B, the tenant ID, and the time-bound token to the communication controller 116 hosted on the cloud platform 110. As will be appreciated, in some examples, the actions performed at operations 914 and 916 are out-of-band actions, wherein the information, such as, the SSIDs, the time-bound tokens, and the tenant ID, is provided by the customer (e.g., the first tenant) or the administrator, thus proving that the customer (e.g., the first tenant) or the administrator providing this information is in control of the on-premise network 102 and the process of configuring the secure communication tunnel 112.

Further, once the information (e.g., the SSIDs, the time-bound tokens, and the tenant ID) is received by the communication controller 116, the communication controller 116, at operation 918, may select a communication delegate that is mapped to the provided tenant ID. In the current example, if the tenant ID provided at operations 914 and 916 is ‘1234’ which is corresponding to the first tenant associated with the on-premise network 102, the communication controller 116 may select the communication delegate 118A using the delegate-tenant mapping 408. Moreover, at operation 920, the communication delegate 118A may be operationalized (i.e., is run/executed) so that it establishes a secure communication channel with the midway server 120. This secure connection channel between the communication delegate 118A and the midway server 120 is referred to as a first communication tunnel 124A. In some examples, the operations 914, 916 of supplying the information via the UI, selecting the communication delegate mapped to the tenant ID, and establishing the first communication tunnel 124A by operationalizing (i.e., is run/executed) the communication delegate 118A are collectively referred to as a pinning operation. Accordingly, at the end of the pinning operation, the secure communication tunnel 112 may be established between the communication delegate 118A and the on-premise network 102. As will be appreciated, use of time-bound tokens in the pinning operation enhances security of the pinning operation.

Furthermore, in some examples, at operation 922, a first plurality communication links may be established within the secure communication tunnel 112 between the communication delegate 118A and the RCA 122A, wherein the encrypted data traffic is transported over one or more of the first plurality of communication links. Also, in some examples, at operation 924, a second plurality of communication links may be established within the secure communication tunnel 112 between the communication delegate 118A and the RCA 122B, wherein the encrypted data traffic is transported over one or more of the second plurality of communication links when the RCA 122A is non-operational.

Although the secure communication tunnel 112 has been established, it may not be accessible to tenant users. In order for the tenant users to access and use the secure communication tunnel 112, in some examples, at operation 926, the communication controller 116, may map the secure communication tunnel 112 to a unique URL accessible by the tenant. In particular, in order to map the secure communication tunnel 112 to the unique URL, in some examples, the communication controller 116 may first map the secure communication tunnel 112 to the application service 121 (e.g., a Kubernetes service). The application service 121 may create an ingress which is an external end point as the unique URL. In particular, the tenant users can open the unique URL via a web-browser or via a mobile application and can access the on-premise application 108 for various management operations thereon upon successful authentication.

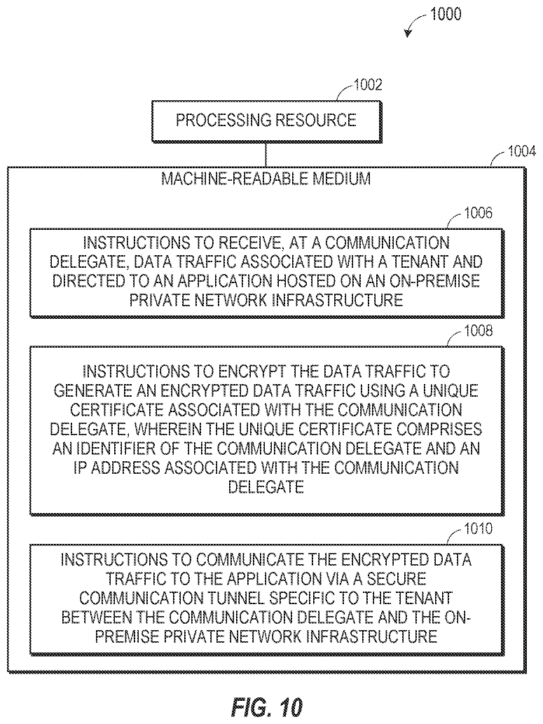

FIG. 10 is a block diagram 1000 depicting a processing resource 1002 and a machine-readable medium 1004 encoded with example instructions to direct data traffic to respective communication delegates of the communication delegates 118A-118C in the cloud platform 110, in accordance with an example. The machine-readable medium 1004 may be non-transitory and is alternatively referred to as a non-transitory machine-readable medium 1004. In some examples, the machine-readable medium 1004 may be accessed by the processing resource 1002. In some examples, the processing resource 1002 may represent one example of the processing resource 402 of the communication controller 116. Further, the machine-readable medium 1004 may represent one example of the machine-readable medium 404 of the communication controller 116. As described in detail herein, the machine-readable medium 1004 may be encoded with executable instructions 1006, 1008, and 1010 (hereinafter collectively referred to as instructions 1006-1010) to direct the data traffic to respective communication delegate of the communication delegates 118A-118C. Although not shown, in some examples, the machine-readable medium 1004 may be encoded with certain additional executable instructions to perform operations at one or more blocks in the method 700 described in FIG. 7, and/or any other operations performed by the communication controller 116, without limiting the scope of the present disclosure.

In some examples, the processing resource 1002 may fetch, decode, and execute the instructions 1006-1010 stored in the machine-readable medium 1004 to enable routing of the data traffic to respective one of the communication delegates 118A-118C. In certain examples, as an alternative or in addition to retrieving and executing the instructions 1006-1010, the processing resource 1002 may include at least one integrated circuit, other control logic, other electronic circuits, or combinations thereof that include a number of electronic components for performing the functionalities intended to be performed by the communication controller 116.

The instructions 1006, when executed by the processing resource 1002, may cause the processing resource 1002 to receive the data traffic that is supposed to be communicated to any external recipient from the cloud platform 110. Further, the instructions 1008, when executed by the processing resource 1002, may cause the processing resource 1002 to identify a communication delegate mapped to the tenant from among a plurality of communication delegates 118A-118C based on the tenant ID identified from the data traffic received by the communication controller 116. Each of the plurality of communication delegates 118A-118C may be mapped respectively to a unique tenant of a plurality of tenants of the cloud platform 110. Further, the instructions 1010, when executed by the processing resource 1002, may cause the processing resource 1002 to forward the data traffic to the communication delegate that is mapped to the tenant.

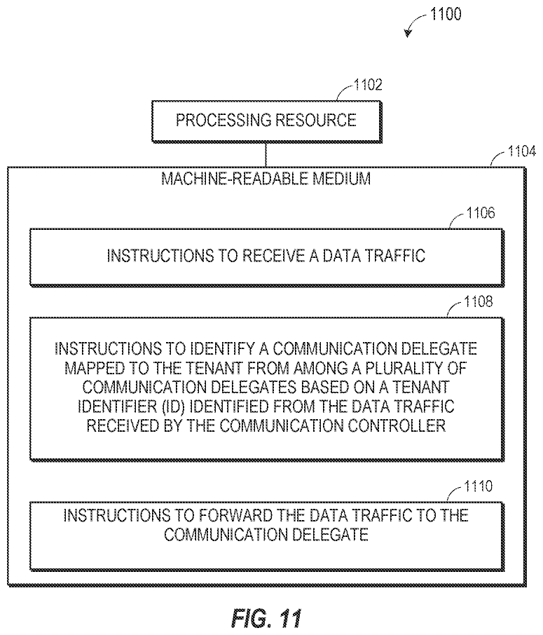

FIG. 11 is a block diagram 1100 depicting a processing resource 1102 and a machine-readable medium 1104 encoded with example instructions to communicate the data traffic from the cloud platform 110 hosted on the cloud network 104 to the on-premise application 108 hosted on the on-premise network 102, in accordance with an example. The machine-readable medium 1104 may be non-transitory and is alternatively referred to as a non-transitory machine-readable medium 1104. In some examples, the machine-readable medium 1104 may be accessed by the processing resource 1102. In some examples, the processing resource 1102 may represent one example of the processing resource 502 of the communication controller 116. Further, the machine-readable medium 1104 may represent one example of the machine-readable medium 504 of the communication controller 116. As described in detail herein, the machine-readable medium 1104 may be encoded with executable instructions 1106, 1108, and 1110 (hereinafter collectively referred to as instructions 1106-1110) to communicate the data traffic from the cloud platform 110 hosted on the cloud network 104 to the on-premise application 108 hosted on the on-premise network 102. Although not shown, in some examples, the machine-readable medium 1104 may be encoded with certain additional executable instructions to perform operations at one or more blocks in the methods 600 and 700 described in FIGS. 6-7, and/or any other operations performed by the communication delegate 118A, without limiting the scope of the present disclosure.

In some examples, the processing resource 1102 may fetch, decode, and execute the instructions 1106-1110 stored in the machine-readable medium 1104 to communicate the data traffic from the cloud platform 110 to the on-premise application 108. In certain examples, as an alternative or in addition to retrieving and executing the instructions 1106-1110, the processing resource 1102 may include at least one integrated circuit, other control logic, other electronic circuits, or combinations thereof that include a number of electronic components for performing the functionalities intended to be performed by the communication delegate 118A.

The instructions 1106, when executed by the processing resource 1102, may cause the processing resource 1102 to receive data traffic associated with a tenant (e.g. the first tenant) and directed to the on-premise application 108 hosted on an on-premise network 102 of the first tenant. Further, the instructions 1108, when executed by the processing resource 1102, may cause the processing resource 1102 to encrypt the data traffic to generate an encrypted data traffic using a unique certificate (e.g., the certificate 300) associated with the communication delegate (e.g., the communication delegate 118A). Furthermore, the instructions 1106, when executed by the processing resource 1102, may cause the processing resource 1102 to communicate the encrypted data traffic to the on-premise application 108 via the secure communication tunnel 112 specific to the first tenant between the communication delegate 118A and the on-premise network 102.

While certain implementations have been shown and described above, various changes in form and details may be made. For example, some features and/or functions that have been described in relation to one implementation and/or process can be related to other implementations. In other words, processes, features, components, and/or properties described in relation to one implementation can be useful in other implementations. Furthermore, it should be appreciated that the systems and methods described herein can include various combinations and/or sub-combinations of the components and/or features of the different implementations described.

In the foregoing description, numerous details are set forth to provide an understanding of the subject matter disclosed herein. However, implementation may be practiced without some or all of these details. Other implementations may include modifications, combinations, and variations from the details discussed above. It is intended that the following claims cover such modifications and variations.

What is claimed is:

1. A method comprising:
receiving, by a communication delegate hosted on a cloud platform and mapped to a tenant of the cloud platform, data traffic associated with the tenant and directed to an application hosted on an on-premise private network of the tenant, wherein the cloud platform is hosted outside of the on-premise private network;
encrypting, by the communication delegate, the data traffic to generate an encrypted data traffic using a unique certificate associated with the communication delegate; and
communicating, by the communication delegate, the encrypted data traffic to the application via a secure communication tunnel specific to the tenant between the communication delegate and the on-premise private network.

2. The method of claim 1, wherein the application is provided to the tenant on a pay-per-use basis.

3. The method of claim 1, further comprising:
receiving, by a communication controller of the cloud platform, the data traffic prior to receiving the data traffic by the communication delegate;
identifying, by the communication controller, the communication delegate mapped to the tenant from among a plurality of communication delegates based on a tenant identifier (ID) identified from the data traffic received by the communication controller, wherein each of the plurality of communication delegates is mapped respectively to a unique tenant of a plurality of tenants of the cloud platform; and
forwarding, by the communication controller, the data traffic to the communication delegate.

4. The method of claim 1, further comprising retrieving, by the communication delegate, the unique certificate associated with the communication delegate from a certificate store.

5. The method of claim 1, wherein the unique certificate comprises an identifier of the communication delegate and an IP address associated with the communication delegate.

6. The method of claim 1, wherein the secure communication tunnel comprises a first communication tunnel between the communication delegate and a midway server, and wherein communicating the encrypted data traffic comprises sending the encrypted data traffic from the communication delegate to the midway server via the first communication tunnel.

7. The method of claim 6, wherein the secure communication tunnel further comprises a second communication tunnel between the midway server and a remote communication agent hosted at the on-premise private network and linked to the application, and wherein communicating the encrypted data traffic comprises:
verifying a delegate ID and an IP address associated with the encrypted data traffic at the midway server against the unique certificate; and
forwarding the encrypted data traffic from the midway server to the remote communication agent via the second communication tunnel upon successful verification of the delegate ID and the IP address associated with the encrypted data traffic.

8. The method of claim 1, wherein the secure communication tunnel comprises a first communication tunnel between the communication delegate and a midway server,
the method further comprising:
establishing the first communication tunnel by mapping the communication delegate with a remote communication agent linked to the application based on one or more of a tenant ID, a time-bound token, and an identifier of the remote communication agent hosted at the on-premise private network, and
operationalizing the communication delegate to connect securely to the midway server.

9. The method of claim 1, wherein the secure communication tunnel comprises a second communication tunnel between a remote communication agent hosted at the on-premise private network and a midway server,
the method further comprising:
establishing the second communication tunnel by configuring the remote communication agent with an identifier of the communication delegate, and
operationalizing the remote communication agent to connect securely to the midway server.

10. The method of claim 1, further comprising linking a remote communication agent associated with the application and hosted at the on-premise private network with the application by allocating an IP address and a port associated with the application to the remote communication agent.

11. The method of claim 1, further comprising mapping the secure communication tunnel to a unique Uniform Resource Locator (URL) accessible by the tenant.

12. The method of claim 1, further comprising establishing a plurality of communication links within the secure communication tunnel between the communication delegate and a remote communication agent, wherein the encrypted data traffic is transported over one or more of the plurality of communication links.

13. A cloud platform system, comprising:
a certificate store to store a plurality of unique certificates; and
a communication delegate mapped to a tenant of the cloud platform system to:
receive data traffic associated with the tenant and directed to an application hosted on an on-premise private network, wherein the cloud platform system is hosted on a cloud platform outside of the on-premise private network;
encrypt the data traffic to generate an encrypted data traffic using a unique certificate associated with the communication delegate selected from the plurality of unique certificates stored in the certificate store, wherein the unique certificate comprises an identifier of the communication delegate and an IP address associated with the communication delegate; and
communicate the encrypted data traffic to the application via a secure communication tunnel specific to the tenant between the communication delegate and the on-premise private network.

14. The cloud platform system of claim 13, further comprising a communication controller to:
receive the data traffic prior to receiving the data traffic by the communication delegate;
identify the communication delegate mapped to the tenant from among a plurality of communication delegates based on a tenant identifier (ID) identified from the data traffic received by the communication controller, wherein each of the plurality of communication delegates is mapped respectively to a unique tenant of a plurality of tenants of the cloud platform; and
forward the data traffic to the communication delegate.

15. The cloud platform system of claim 14, wherein the plurality of communication delegates are hosted as containerized applications on one or more clusters of computing nodes, and
wherein the IP address associated with the communication delegate comprises an IP address of a cluster of the one or more clusters of computing nodes that hosts the communication delegate.

16. The cloud platform system of claim 15, wherein the communication delegate is to retrieve the unique certificate associated with the communication delegate from a certificate store.

17. The cloud platform system of claim 13, wherein the secure communication tunnel comprises a first communication tunnel between the communication delegate and a midway server, and
wherein the encrypted data traffic is sent from the communication delegate to the midway server via the first communication tunnel.

18. The cloud platform system of claim 17, wherein the secure communication tunnel comprises a second communication tunnel between the midway server and a remote communication agent hosted at the on-premise private network,
wherein the midway server is to:
verify a delegate ID and an IP address associated with the encrypted data traffic against the unique certificate; and
forward the encrypted data traffic from the midway server to the remote communication agent via the second communication tunnel upon successful verification of the delegate ID and the IP address associated with the communication delegate.

19. A non-transitory machine-readable medium storing instructions executable by a processing resource, the instructions comprising:
instructions to receiving at a communication delegate hosted on a cloud platform and mapped to a tenant of a cloud platform, data traffic associated with the tenant and directed to an application hosted on an on-premise private network, wherein the cloud platform is the cloud platform outside of the on-premise private network;
instructions to encrypt the data traffic to generate an encrypted data traffic using a unique certificate associated with the communication delegate, wherein the unique certificate comprises an identifier of the communication delegate and an IP address associated with the communication delegate; and
instructions to communicate the encrypted data traffic to the application via a secure communication tunnel specific to the tenant between the communication delegate and the on-premise private network.

20. The non-transitory machine-readable medium of claim 19, wherein the communication delegate mapped to the tenant is selected from among a plurality of communication delegates based on a tenant ID identified from the data traffic received by a communication controller,
wherein each of the plurality of communication delegates is mapped respectively to a unique tenant of a plurality of tenants of the cloud platform.
